(19) United States
(12) Patent Application Publication
(10) Pub. No.: US 2026/0317108 A1
(43) Pub. Date: Oct. 15, 2026

(54) Winder with a Diameter Profile Measuring System and a Diameter Profile Measuring Method

(71) Applicant: Valmet Technologies Oy, Espoo (FI)

(72) Inventors: Jyri Ahrapalo, Järvenpää (FI); Jaakko Haapanen, Vantaa (FI); Marko Kääriäinen, Vantaa (FI); Arto Leskinen, Järvenpää (FI); Tuomas Ratilainen, Vantaa (FI); Henry Virta, Vantaa (FI)

(73) Assignee: Valmet Technologies Oy, Espoo (FI)

(21) Appl. No.: 19/538,236

(22) Filed: Feb. 12, 2026

(30) Foreign Application Priority Data
Feb. 18, 2025 (FI) 20255140

(51) Int. Cl. B65H 26/06; B65H 18/10

(52) U.S. Cl. CPC B65H 26/06; B65H 18/10

(57) ABSTRACT

A winder (10) of a slitter-winder configured to wind customer rolls (15) as sets of customer rolls (15) has two winding drums (11, 12), on support of which customer rolls (15) are wound. A rider roll (17) is supported by a rider roll beam (18) to support customer rolls (15) from above during winding and is movable vertically. The rider roll beam (18) has a linear guide. A diameter profile measuring system has a diameter profile measuring device (20) supported by a carriage (22) on the linear guide (21), and has a measuring laser sensor which is pivotably attached to the carriage (22) for calibration. During operation the laser measures distance to customer rolls; for calibration it is pivoted to measure distance to the winding drums so the laser can be calibrated in relation to them, allowing calibration on the whole width and at each point of the width.

### CROSS REFERENCES TO RELATED APPLICATIONS

This application claims priority on Finnish Application No.20255140, filed Feb. 18, 2025, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates generally to production of fiber webs and to slitting and winding of fiber webs into customer rolls, especially by a slitter-winder for fiber webs. The invention relates to a winder with a diameter profile measuring system and method.

As known, fiber webs, such as paper or board webs, are manufactured in machines together forming a fiber web manufacturing line, which may be hundreds of meters long. Modern paper machines may produce more than 450,000 tons of paper per year. The speed of a paper machine may exceed 2000 m/min and the width of a paper web may be more than 11 meters.

As known from the prior art in fiber web producing processes typically comprise an assembly formed by a number of apparatuses arranged consecutively in the process line. A typical production and treatment line comprises a head box, a wire section and a press section as well as a subsequent drying section and a reeler or a winder. The production and treatment line can further comprise finishing devices, for example a sizer and/or a calender and/or a coater. The production and treatment line also comprises typically at least one slitter-winder for forming customer rolls as well as a roll packaging apparatus.

In fiber web production lines, manufacturing operates as a continuous process. The finished fiber web being output from the machine is wound with a reeler or a winder around a reeling shaft, i.e. a reel spool, into a parent roll (a machine roll), the diameter of which may be more than 5 meters and which may weigh more than 160 tons. The purpose of the reeling is to transfer the fiber web from its planar manufacturing form into a form in which it can be handled more easily. At the reeler, which is located in the main production line, the continuous process of the production line is interrupted for the first time, after which the process continues in stages. Every attempt is made to interlink these stages as smoothly as possible so that the work already performed would not be wasted. Reelers are thus used in fiber web production for reeling the fiber web coming from the fiber web production line into a parent roll, but reelers are also used to reel fiber web coming from a coating machine, a calender or a corresponding finishing device.

The fiber web wound in the reel-up onto the parent roll is full-width so it must be slit in longitudinal direction into partial webs with suitable width and the partial webs are wound to partial fiber web rolls (customer rolls) with suitable length of fiber web and/or of suitable diameter for the customers. The slitting and winding take place as known from prior art in an appropriate separate machine i.e. in a slitter-winder. Slitter-winders comprise an unwinder, in which the parent roll is unwound, a slitting section, in which from the parent roll unwound fiber web is slitted, i.e. cut in longitudinal direction, to partial webs with desired widths, and a winding section for winding the customer rolls. In winding sections of slitter-winders winding devices of different types are employed, for example multistation winders and two-drum winders. As known in the prior art, also winding with a shaft without cores or together with cores can be employed in the winding of a fiber web into customer rolls on a slitter-winder. On slitter-winders of the multistation winder type, the fiber web is guided from the unwinding via guide rolls to the slitting section where the fiber web is slit into partial webs which are further guided either from above or from below to the winding roll/rolls of the winding stations to be wound up onto cores into customer rolls. Adjacent partial webs are wound up on different sides of the winding roll/on different winding rolls. Multistation winders have one to three winding rolls and in them each partial web is wound to a partial web roll in its own winding station. During winding a winding nip is formed between the winding roll and the partial web rolls to be wound. In the two-drum winders the partial webs are wound around winding cores supported by two winding drums to customer rolls via a nip between the winding drums and the customer roll being formed. In the two-drum winders also a belt arrangement i.e. a so-called set of belt rolls with belt loop or belt loops located around two guide rolls can be used as the winding drum. During winding a winding nip is formed between the winding drums and the customer rolls wound. In the two drum winders typically also a rider roll is used to support the customer rolls in winding from above. The rider roll is supported by a rider roll beam, which is arranged to be movable typically in the vertical direction to be in contact with the customer rolls during winding and to be correspondingly moved upwards as the diameter of the customer rolls increases.

As known from the prior art, in the slitter-winder the parent roll is unwound in an unwinding section in at least one unwinder, the full-width fiber web is slit in the longitudinal direction on the slitting section into several narrower partial fiber webs (partial webs), which are wound up on a winding section around winding cores into customer rolls as sets. In the slitter-winder when the customer rolls reach the desired length and diameter, a set change is performed, in which the rider roll is removed from the contact with the customer rolls and the partial webs are cut in the cross-direction. Tails of the partial webs, i.e. trailing ends of the cut partial webs, are attached onto the surface of the fiber webs on the surface of customer rolls in the set change by applying onto the surface of the fiber web running towards the customer rolls adhesive, which then attaches the tails onto the surface of the customer rolls. When the customer rolls are completed, in the slitter-winder in the set change the complete customer rolls, i.e. the so-called set, is removed from the winder and new cores for winding the next set of the customer rolls are set to the winder onto support of the winding drums and the beginning ends of the cut partial webs are attached onto the new cores, and the rider roll is moved to support the customer rolls to be wound, after which the process is continued with the winding of the next set of the customer rolls. These stages are repeated periodically until paper runs out of the parent roll in the unwinder, whereby a parent roll change is performed and the operation starts again as the unwinding of a next parent roll and forming the customer rolls in sets.

One important factor effecting runnability of a slitter-winder is diameter profile of a set of customer rolls. Sometimes the profile in the cross-direction of the fiber web of a full-width fiber web produced by a fiber web production line is such that, in winding a set of customer rolls, the diameters of the customer rolls differ from each other, sometimes even significantly, which causes the customer rolls of the set to not all be in contact with the rider roll of the two drum winder and also, customer rolls with different diameters can have different angular speeds. These may cause severe vibration. The vibration phenomenon may cause problems in winders—even a 1 mm difference in diameters of the customer rolls may cause vibration and/or have an effect on the runnability of the winder. The vibration causes winding reject, mechanical wear of the parts and element of the slitter-winder, even loosening of the customer rolls from the winder as well as a decrease of winding capacity as the running speed has to be lowered. The vibration phenomenon thus often limits the maximum speed utilizable in the winding and therefore decreases the capacity of the slitter-winder. In the worst case, the vibration phenomenon can cause the out-throwing of the set of the customer rolls from the winder. Additionally, web breaks may occur due to the vibration phenomenon.

It is known from prior art that sometimes hardness measurement has been used to define a diameter profile of a set of customer rolls, as a correlation between the hardness and the diameter profile of the set of the customer rolls exits. WO patent application publication 2010028867A1 discloses one example of this type of an arrangement. In practice, this arrangement is seldom used due to its relative high costs.

FI utility model publication 13651Y1 discloses a slitter-winder, which comprises a slitting section for slitting a fiber web in the longitudinal direction of the fiber web into partial webs, a spreading device for separating the partial webs in the lateral direction such that a distance is formed between adjacent partial webs, a winding section for winding the partial webs into customer rolls comprising at least one winding drum for supporting and winding the customer rolls by a winding nip formed between the winding drum and the customer rolls during winding. The slitter-winder further comprises a traversable measuring device/-s located after the spreading device in the running direction of the partial webs for measuring the distance between adjacent partial webs and/or gaps between adjacent customer rolls, a spreading adjustment actuator/-s for adjusting the spreading/separating effect of the spreading device and a controller configured to receive measurement result/-s from the traversable measuring device/-s and to automatically control the spreading adjustment actuator/-s. The measuring device/-s for measuring the gaps between the customer rolls can be attached to a rider roll or to a rider roll beam of the winder. This/these measuring device/-s can also provide information of the widths of the customer rolls and of their positions on the winding drums and of the diameter profile of a set of customer rolls. In this arrangement measurement information can be provided to a controller connected to a control unit of a slitter-winder. In practice this type of measuring device has not been used to measure diameter profiles of a set of customer rolls due to difficulties in calibrating the measurement such that reliable results are provided. Furthermore, it should be noted that by controlling the slitter-winder not significant effect to diameter profile of a set of customer rolls can be provided.

Therefore there exists a need for diameter profile measurement in connection with winders of slitter-winders to provide measurement information in regard of diameter profiles of sets of customer rolls to the fiber web production line for controlling the production of the fiber web such that unevenness in the cross-directional profile of the fiber web can be eliminated or at least minimized such that differences in diameters of customer rolls of a set of customer rolls can be avoided or at least minimized.

An object of the present invention is to create a diameter profile measuring system and a diameter profile measuring method, in which the above problems and disadvantages are eliminated or at least minimized.

A particular object of the present invention is to provide an improved diameter profile measuring system and an improved diameter profile measuring method, by which reliable results are achieved and necessary back feed information to a fiber web production line can be provided.

### SUMMARY OF THE INVENTION

According to the invention the winder with a diameter profile measuring system is a winder of a slitter-winder and configured to wind customer rolls as sets of customer rolls, which winder has two winding drums, on support of which the customer rolls are configured to be wound, and a rider roll supported by a rider roll beam, which rider roll is configured to support the customer rolls during winding thereof from above, and which rider roll and rider roll beam are arranged to be movable in the vertical direction, wherein the rider roll beam comprises a linear guide located on its longitudinal side. The diameter profile measuring system has a diameter profile measuring device supported by a carriage. The measuring device is movably supported by the carriage on the linear guide. The diameter profile measuring device has a measuring laser sensor and the measuring laser sensor is turnable by a turnable attachment arrangement attached to the carriage for calibration measurement of the measuring laser sensor.

According to an advantageous feature of the invention the measuring device has a measurement movement, in which the measuring device is configured to be moved on the linear guide in a cross-direction of the winder and during which the measuring laser sensor of the measuring device is configured to measure distance to an outer peripheral surface of the customer rolls to define the diameter profile of the set of the customer rolls supported by the winding drums.

According to an advantageous feature of the invention the diameter profile measurement information received from the measuring laser sensor is configured to be calibrated on the basis of calibration distance measurement information of a distance to at least one of the winding drums.

According to an advantageous feature of the invention the measuring system has an actuator for moving the measuring device.

According to an advantageous feature of the invention the measuring system has a charging position with a charging device for charging the measurement device.

According to an advantageous feature of the invention the measurement device of the measuring system is in data transmission connection with a slitter-winder control system.

According to an advantageous feature of the invention the slitter-winder control system is in data transmission connection with a production line control unit of a fiber web production line, in connection of which the winder is arranged, and configured to provide back feed information to the production line control unit on the basis of the measured diameter profile information received from the measuring device.

According to an advantageous feature of the invention the measuring device is wireless.

According to the invention the diameter profile measuring method for measurement of diameter profile of a set of customer rolls wound in a winder of a slitter-winder, which winder sets of customer rolls are wound on the support of winding drums of the winder, and in which winder a set of customer rolls is supported from above by a rider roll supported by a rider roll beam, whereby in the diameter profile measuring method a diameter profile is measured by a diameter profile measuring device during measurement movement of the diameter profile measuring device provided by a carriage movably supported on a linear guide arranged on one longitudinal side of the rider roll beam, the diameter profile measuring device measures the diameter profile of a set of customer rolls by a measuring laser sensor, which is turnable by a turnable attachment arrangement attached to the carriage for calibration measurement of the measuring laser sensor.

According to an advantageous feature of the invention the diameter profile measuring is performed when the winder is slowing down or stopped.

According to an advantageous feature of the invention the diameter profile measuring is performed when the winder is for a set change slowing down or stopped.

According to an advantageous feature of the invention the measuring laser sensor is turned for the calibration distance measurement of measuring distance to at least one of the winding drums by the measuring laser sensor.

According to an advantageous feature of the invention in the method, the measuring device is charged in a charging position by a charging device.

According to an advantageous feature of the invention in the method the measurement result of the diameter profile measurement by the measuring device is transmitted to a slitter-winder control system for transmitting the measurement result as back feed information to a production line control unit of a fiber web production line providing fiber web for the winder.

The present invention provides a novel and inventive diameter profile measurement in connection with a slitter-winder. By the diameter profile measuring system and the diameter profile measuring system according to the invention the diameter profile of a set of customer rolls wound in a winder of a slitter-winder is measured reliably and thus the diameter profile measurement results can be used as back feed information in the fiber web production line.

It has been surprisingly noted that the measuring device of the diameter profile measuring system and for the diameter profile method for measuring the diameter profile of a set of customer rolls wound provides reliable information in regard of the diameter profile of a set of customer rolls, as the measurement results are received from the traversing measuring device provided with a turnable laser sensor, which turnability provides setting the laser sensor of the measurement device to a calibration measurement position. Thus, the laser sensor of the measurement device comprises two main positions: diameter profile measurement position and calibration measurement position. In the diameter profile measurement is measured distance to the outer surfaces of the customer rolls and in the calibration measurement is measured distance to at least one of the winding drums.

It has been surprisingly noted that the measuring device of the diameter profile measuring system and for the diameter profile method for measuring the diameter profile of a set of customer rolls wound in a two drum winder of a slitter-winder, which measuring device is arranged as a traversing measuring device attached to a rider roll beam of the respective two drum winder, is advantageously calibrated by measuring the position of the measurement laser sensor in respect of position of at least one of the winding drums and calibrating the measurement information of the diameter profile on the basis of this calibrating measurement result. Advantageously for the calibration the position of the measurement laser sensor is measured in respect of each of the winding drums for positioning the measurement laser sensor advantageously in a vertical and in a machine direction (in the main running direction of the slitter-winder). Advantageously based on the calibrating measurement results a correction factor for the diameter profile measurement result of a set of the customer rolls is defined. Further, it has surprisingly been found out that by providing the measurement laser sensor of the measuring device with the turnable attachment arrangement to the rider roll beam, the calibration measurement can be performed on the basis of the distance to at least one of the winding drums and thus, the correction factor for the measurement laser sensor diameter profile measurement results can be defined for reliable, calibrated diameter profile measurement information. The turnable attachment arrangement can be arranged for example by a turning link or by an adjustable screw fastening. The turned calibration position of the laser sensor is defined on basis of geometry of the winder.

According to an advantageous aspect of the invention in the diameter profile measuring device the measuring laser sensor has an accuracy of +/−0.2 mm. It should be noted that mounting movably a sensor with this accuracy onto a carriage movably on a guide arranged on the rider roll beam is a challenge, in which the accuracy may easily be lost. Thus, the measuring laser sensor turnably by the turnable attachment arrangement attached to the carriage for calibration measurement of the measuring laser sensor provides accuracy of at least +/−0.5 mm. Especially, the calibration measurement as the distance measurement to at least one of the winding drums provides a very accurate calibration due to the accurate machining of the surface of the winding drums.

Further advantageously, the diameter profile measurement results received are transmitted by a transmission unit wirelessly to a control system of a fiber web production line, in connection of which the slitter-winder is located, and/or to a part thereof to provide diameter profile information for controlling the fiber web production such that a fiber web with improved profile, such that the diameter profile of a set of customer rolls is substantially even and, thus, the rider roll supports the customer rolls of the set during winding evenly and the harmful vibration effect is eliminated or at least minimized.

According to an advantageous aspect of the invention in a two drum winder provided with a rider roll supported by a rider roll beam on support structures of the two drum winder, the rider roll beam comprises a horizontal guide on one longitudinal side thereof, i.e. a cross-direction extending side in respect of the main running direction of the fiber webs, i.e. in the axis direction of the customer rolls of the set wound in the winder, and to the horizontal guide a traversing measuring device is movably attached in the horizontal direction. The traversable measuring device comprises a measuring laser sensor configured to measure the distance from the surface of each of the customer rolls in the set to provide diameter profile information of the diameters of the customer rolls of the set. The measuring is advantageously performed after a set of customer rolls is completed, when the rider roll has been removed upwards from contact with the surface of the customer rolls. The measuring is alternatively advantageously performed just before a set of customer rolls is completed, when the rider roll is still in contact with the surface of the customer rolls. These alternatives provide that the measuring can be performed without taking off capacity of the slitter-winder. The measuring laser sensor is calibrated by measuring the position of the measurement laser sensor in respect of the position of at least one of the winding drums and calibrating the measurement results on the basis of this calibrating measurement result. Advantageously for the calibration the position of the measurement laser sensor is measured in respect of each of the winding drums.

According to an advantageous aspect of the invention the measuring device of the diameter profile measuring system and for the diameter profile method for measuring the diameter profile of a set of customer rolls wound in a two drum winder of a slitter-winder is automatically controlled.

According to an advantageous aspect of the invention the measuring device of the diameter profile measuring system and for the diameter profile method for measuring the diameter profile of a set of customer rolls wound in a two drum winder of a slitter-winder is integrated to the slitter-winder.

According to an advantageous aspect of the invention the measuring device of the diameter profile measuring system and for the diameter profile method for measuring the diameter profile of a set of customer rolls wound in a two drum winder of a slitter-winder can additionally perform measurements of gaps between the adjacent customer rolls in a set of customer rolls and widths of customer rolls in a set of customer rolls.

According to an advantageous aspect of the invention the measuring device has a charging position with a charging device, in which the measuring device is charged during its rest times, if needed, such, that continuous operation is provided and the measuring device will be continuously powered for measurement movement and thus, always available for the measurement of the diameter profile at its measuring times.

According to an advantageous aspect of the invention based on the diameter profile measurement result information, the back feed information to the control of the fiber web production line, effects corrective operations in the fiber web production to provide a more even full-width fiber web profile. These corrective operations may be, for example, adjustment of suspension feed from the headbox in the cross-direction, adjustment of cross-directional loading profiles in the press-section, adjusting at least one steam box effect in the cross-direction, adjustment of temperature profile of at least one calender roll in the cross-direction or adjusting moisture devices in the cross-direction.

According to an advantageous aspect of the invention based on the diameter profile measurement result information, the back feed information to the control of the slitter-winder, effects corrective operations to avoid vibration and/or to provide more even diameter profile for a set of customer rolls.

By the invention and its advantageous features many advantages are achieved: reliable measuring information in regard to the diameter profile of a set of customer rolls is provided and the measuring information can be provided as back feed information to the control of the fiber web production line to improve the profile of the fiber web such that evenness of the diameter profile of sets of customer rolls wound in the winder of the slitter-winder is improved and, thus, harmful vibrations can be avoided and the runnability of the slitter-winder is improved. The accurate calibration provides for even +/−0.5 mm accuracy of the diameter profile information.

### BRIEF DESCRIPTION OF THE DRAWINGS

Aspects and features of the invention, however, together with additional objects and advantages thereof, will be best understood from the following description of some example embodiments when read in connection with the accompanying drawings. In the following the invention is described in more detail referring to the accompanying drawing.

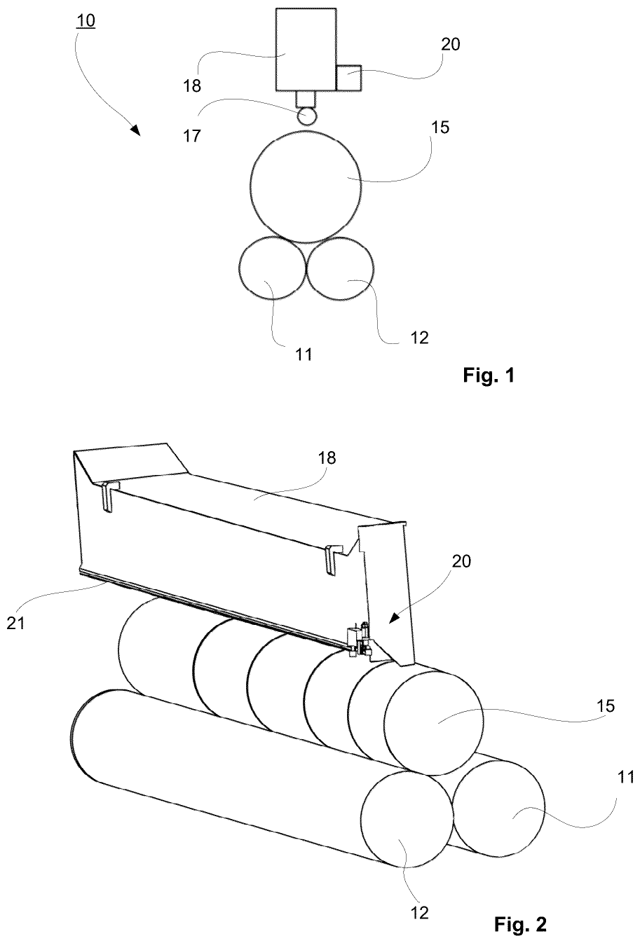

In FIG. 1 is schematically shown an advantageous example of a winder or a slitter-winder with a diameter profile measuring system for the diameter profile measuring method.

In FIG. 2 is schematically shown an advantageous example of part of the winder of the slitter-winder with the diameter profile measuring system for the diameter profile measuring method as a 3D view.

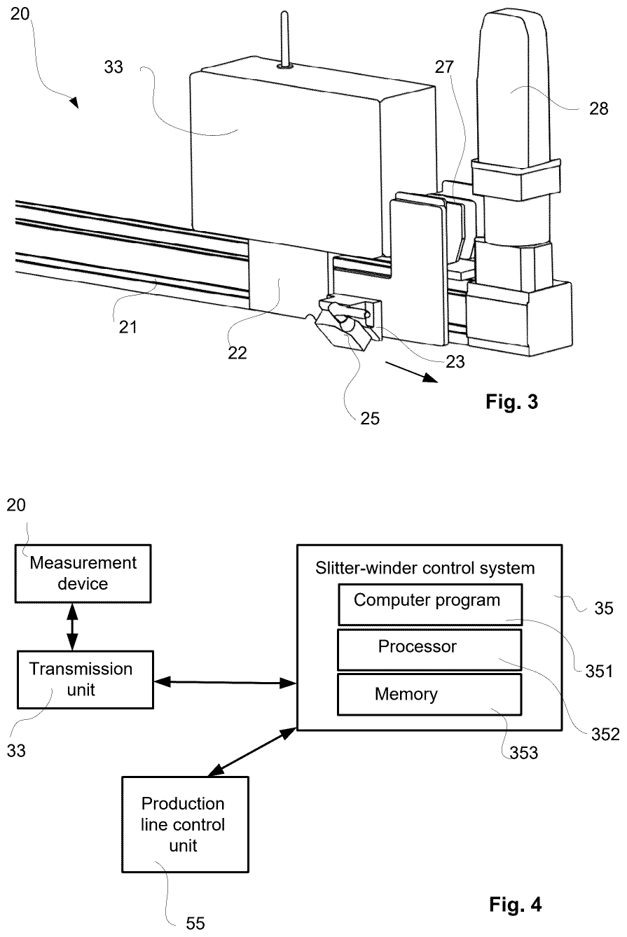

In FIG. 3 is schematically shown an advantageous example of a diameter profile measuring device for the diameter profile measuring system.

In FIG. 4 is schematically shown an advantageous example of a control system of a diameter profile measuring device for the diameter profile measuring system.

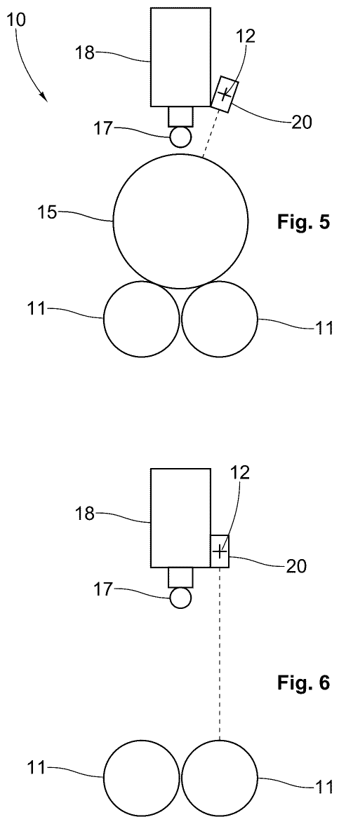

In FIG. 5 is schematically shown the diameter profile measuring system with the measurement device directed to measure the diameter profile of the customer rolls.

In FIG. 6 is schematically shown the diameter profile measuring system with the measurement device directed to measure the distance to a winding drum for calibration purposes.

### DESCRIPTION OF THE PREFERRED EMBODIMENTS

In the following description the same reference signs designate similar components unless otherwise mentioned. It should be understood that the examples are susceptible of modification in order to adapt to different usages and conditions within the frames of the invention. Repetition of some reference signs may have been omitted in the figures for clarity.

In FIG. 1 is shown an example of the diameter profile measuring system for the diameter profile measuring method in connection with a winder 10 of a slitter-winder, which comprises typically also an unwinder and a slitting section located before the winder 10 in the running direction of the slitter-winder i.e. in the running direction of a fiber web/slitted partial fiber webs in the slitter-winder. In the slitting section the full-width fiber web unwound by the unwinder is guided into slitting between slitter blades, which slitter blades slit the full-width fiber web in the longitudinal direction of the fiber web into the partial fiber webs (partial webs). After slitting the partial webs are guided for winding in the winder 10 on support of winding drums 11, 12 to customer rolls 15 that are located axially next to each other into a longitudinal set of customer rolls in the cross-direction. The customer rolls 15 are spaced apart such that a gap is provided between two adjacent customer rolls 15. As shown in FIG. 1 the slitter-winder also has a rider roll 17 supported by a rider roll beam 18 for supporting the customer rolls 15 during the winding in the winder 10 from above. The rider roll 17 and the rider roll beam 18 are moved in a vertical direction.

In the beginning of a new set of customer rolls 15 the rider roll 17 and the rider roll beam 18 are located at a lowermost position contacting the winding cores around which the customer rolls 15 are to be wound from above and as the winding progresses, and diameters of the customer rolls 15 increase, the rider roll 17 and the rider roll beam 18 are moved correspondingly upwards while contacting the outer circumferential surface of the customer rolls 15. When a set change is performed in the winder 10 the rider roll 17 and the rider roll beam 18 are moved to an uppermost position so as not to be in the way of the set change devices.

The winder 10 also has a diameter profile measuring device 20 for measuring diameter profiles of sets of customer rolls 15 to be wound in the winder 10. For the measuring device 20 a linear guide 21 (FIG. 2) is arranged in connection with the rider roll beam 18 on a longitudinal side thereof, along which linear guide the measuring device 20 is arranged movable in the cross-direction of the winder 10, i.e. in the longitudinal direction of the rider roll beam 18. Thus, the measuring device 20 is traversing. The measuring device 20 comprises a laser sensor for measuring the diameter profile of the sets of the customer rolls 15 wound in the winder 10. The measuring device 20 is thus arranged to be movable over the cross-direction of the winder 10, i.e. over the longitudinal direction of the set of the customer rolls 15. Thus, the measuring device 20 is configured to have a traverse measurement movement in the cross-direction of the winder, during which movement the diameter profile of the set of the customer rolls 15 is measured. The measurement movement is performed, advantageously, when the winder 10 is slowed down, for example for the set change, and/or when the winder 10 is stopped, for example for the set change. During winding the measurement might not give accurate results as the customer rolls 15 may bounce during the winding, especially in case the diameter profile varies so much, that the rider roll 17 is not in contact with all the customer rolls 15 of the set wound. This measuring device 20 can also provide information of the widths of the customer rolls 15 and of their positions on the winding drums 11, 12 and of the gaps between adjacent customer rolls 15. The measurement information of the diameter profile of the set of the customer rolls 15 is transmitted to a slitter-winder control system 35 as shown in FIG. 4, which provides information at least to a production line control unit 55 as back feed information of the cross-directional profile of the full-width fiber web.

In FIG. 2 is shown an example of the diameter profile measuring system for the diameter profile measuring method in connection with a winder 10 (FIG. 1) comprising two winding drums 11, 12 with a set of customer rolls 15 on the winding drums 11, 12. The rider roll beam 18 for supporting the rider roll 17 (FIG. 1) for supporting the customer rolls 15 during the winding in the winder 10 from above has the linear guide 21 which is arranged in connection with the rider roll beam 18 on a longitudinal side thereof, along which linear guide the measuring device 20 is arranged to be movable in the cross-direction of the winder 10, i.e. in the longitudinal direction of the rider roll beam 18.

In FIG. 3 is shown an example of the diameter profile measuring device 20 for the diameter profile measuring system. The measuring device 20 is arranged as a traversing measuring device 20 attached to the rider roll beam 18 (FIGS. 1, 2) of the respective two drum winder 10. Thus, the the rider roll beam 18 comprises the horizontal linear guide 21 on one longitudinal side thereof, and to the horizontal linear guide 21 the traversing measuring device 20 is movably in the horizontal direction attached by a carrier 22. The traversing measuring device 20 comprises the measuring laser sensor 25 supported by the carrier 22 and configured to measure the distance from the surface of each of the customer rolls 15 (FIGS. 1, 2) in the set to provide diameter profile information of the diameters of the customer rolls of the set. The measuring laser sensor 25 is turnable via a turnable attachment arrangement 23 to the rider roll beam 18 and thus, the measuring laser sensor 25 is turnable from a diameter profile measuring position to a calibration measurement position and vice versa.

As shown in FIGS. 5 and 6, the measuring laser sensor 25 pivots about a horizontal axis 12 which extends in the cross direction. The measuring laser sensor 25 emits a laser beam which measures the distance to the customer roll set in a first orientation as shown in FIG. 5. When it is desired to calibrate the measuring laser sensor 25, it is turned to point the laser beam at one or the other of the winding drums 11, 12, when the customer rolls are not present, as shown in FIG. 6. Thus the measuring laser sensor measures a distance to the customer rolls, in somewhat of a middle position, and, for calibration, it is pivoted to measure distance to either of the winding drums. The winding drums are so evenly made that the laser can be calibrated in relation to them. Calibration on the machine has advantages over alternative calibration approaches, such as removing the sensor for calibration and then returning it to its position with all the inherent errors that could arise in that process. Moreover, the calibration may be carried out along the whole width and at each point of the width.

The measuring laser sensor 25 is calibrated by measuring the position of the measurement laser sensor 25 in respect of the position of at least one of the winding drums 11; 12 (FIGS. 1, 2) and calibrating the diameter profile measurement results on the basis of this calibrating measurement result. Advantageously, for the calibration the position of the measurement laser sensor 25 is measured in respect of each of the winding drums 11, 12. Advantageously, for the calibration the position of the measurement laser sensor 25 is measured in respect of each of the winding drums 11, 12 for calibration of the diameter profile measurement information received from the measurement laser sensor 25 advantageously in the vertical and in the machine direction (in the main running direction of the slitter-winder). Advantageously based on the calibrating measurement results a correction factor for a target diameter of a set of the customer rolls is defined. By providing the measurement laser sensor 25 of the measuring device 20 with the turnable attachment arrangement 23 to the rider roll beam 18 the correction factor of the diameter profile measurement of the measurement laser sensor 25 is calculated for reliable, calibrated diameter profile measurement information. The turnable attachment arrangement 23 can be arranged, for example, by a turning link or by an adjustable screw fastening. The measuring device 20 has a charging position with a charging device 27, in which the measuring device 20 is charged when needed. The measuring system further comprises an actuator 28 for moving the measurement device 20 on the linear guide 21. The measurement device 20 is arranged in data transmission connection with the slitter-winder control system 35. The slitter-winder control system 35 may have a power source, such as a battery or it can be connected to a charging device.

In FIG. 4 is shown an example of the control system of the diameter profile measuring device 20 for the diameter profile measuring system and for the diameter profile measuring method. The control system comprises the slitter-winder control system 35 in data connection via a transmission unit 33 with the diameter profile measuring device 20. The slitter-winder control system 35 is a microprocessor or a computer. The measurement results obtained by the diameter profile measuring device 20 are transmitted to the slitter-winder control system 35 and, by analysing the measurement results, the slitter-winder control system 35 can send data to the production line control unit 55 to provide control data relating to the diameter profile of the measured set of the customer rolls 15 (FIG. 1) as back feed information relating to the cross-directional profile of the fiber web. The production line control unit 55 may provide control instructions for corrective operations and/or for informational purposes to the production line and/or the slitter-winder on basis of the diameter profile information.

The control unit 55 of the production line may also provide process data for the slitter-winder control system 35. The diameter profile measurement information can also be saved to a memory device (not shown) and/or to a memory 353 of the slitter-winder control system 35 for later inspection. The slitter-winder control system 35 is in data connection, advantageously wirelessly, with the measurement device 20 via a transmission unit 33 for receiving calibration measurement results and diameter profile measurement information from the diameter profile measurement device 20. The slitter-winder control system 35 advantageously comprises a computer program 351, a processor 352 and a memory 353. Additionally, the slitter-winder control system 35 may also comprise a power supplier and a communicator. The slitter-winder control system 35 is configured to receive the calibration measurement results from the measuring device 20 and, based on the calibration measurement results from the measuring device 20, calculate a correction factor for the diameter measurement result and to define the diameter profile of a set of customer rolls 15 and a variation of diameters of customer rolls 15 of a set.

The slitter-winder control system 35 is configured to receive the measurement results from the measuring device 20 and based on the measurement results from the measuring device 20 and the calibration measurement data define the diameter profile of a set of customer rolls 15 and a variation of diameters of customer rolls 15 of a set.

The slitter-winder control system 35 controls operations of the computer program 351, the processor 352, the memory 353, and additionally the possible power supplier and the communicator. The processor 352 of the slitter-winder control system 35 is advantageously configured to perform at least data transmitting in regard of the measured diameter profile of a set of customer rolls 15 to the production line control unit 55 initiated by the computer program 351. The computer program 351 may comprise one or more computer programs. The processor 352 may comprise one or more processors. The memory 353 of the slitter-winder control system 35 is configured to store and to maintain data relating to the measurement results and transmitted from the measuring device 20 and/or to related information thereof. The data may be instructions, computer programs and/or data files. The memory 353 comprises one or more memories. The memory 353 is configured to store the computer program 351, which is configured to process the measurement result and based on the process to define the back feed information to be transmitted. The memory 353 may also be configured to store at least a communication application for operating (controlling) the communicator and a power supply application for operating the power supplier.

The communicator of the slitter-winder control system 35 can be configured to at least send data to an auxiliary device or devices, either wirelessly or via wire, such as to a remote computer and/or to a laptop computer and/or to a smartphone. The slitter-winder control system 35 can also comprise a power supplier which comprises components that are configured to power the slitter-winder control system 35, such as a battery and a regulator for example.

In the description in the foregoing, although some functions have been described with reference to certain features, those functions may be performable by other features whether described or not. Although features have been described with reference to certain embodiments or examples, those features may also be present in other embodiments or examples whether described or not. Above the invention has been described by referring to some advantageous examples only to which the invention is not to be narrowly limited. Many modifications and alterations are possible within the invention as defined in the following claims.

I claim:

1. A winder with a diameter profile measuring system, the winder being part of a slitter-winder and configured to wind customer rolls as sets of customer rolls, the winder with diameter profile measuring system comprising:
two winding drums positioned to support overlying customer rolls to be wound;
a rider roll beam positioned above the two winding drums, wherein the rider roll beam comprises a linear guide located on a longitudinal side thereof;
a rider roll supported by the rider roll beam and configured to engage and support from above underlying customer rolls supported on the two winding drums during winding thereof, wherein the rider roll and the rider roll beam are movable in a vertical direction;
a diameter profile measuring system comprising a diameter profile measuring device supported by a carriage which is movably supported on the linear guide; and
a measuring laser sensor turnably attached to the carriage for calibration measurement of the measuring laser sensor.

2. The winder with a diameter profile measuring system of claim 1, wherein the measuring device has a measurement movement, in which the measuring device is moved on the linear guide in a cross-direction of the winder and during which the measuring laser sensor of the measuring device is configured to measure distance to an outer peripheral surface of the customer rolls to define the diameter profile of the set of the customer rolls supported by the two winding drums.

3. The winder with a diameter profile measuring system of claim 2, wherein the measured distance to an outer peripheral surface of the customer rolls comprises diameter profile measurement information, and wherein such information is configured to be calibrated on basis of a calibration distance measurement information of a distance to at least one of the two winding drums.

4. The winder with a diameter profile measuring system of claim 1, wherein the measuring system further comprises an actuator for moving the measuring device.

5. The winder with a diameter profile measuring system of claim 1, wherein the measuring system further comprises a charging position with a charging device for charging the measurement device.

6. The winder with a diameter profile measuring system of claim 1, wherein the measurement device of the measuring system is in data transmission connection with a slitter-winder control system.

7. The winder with a diameter profile measuring system of claim 1, wherein the slitter-winder control system is in data transmission connection with a production line control unit of a fiber web production line, in connection of which the winder is arranged, and configured to provide back feed information to the production line control unit based on measured diameter profile information received from the measuring device.

8. The winder with a diameter profile measuring system of claim 1, wherein the measuring device is wireless.

9. A winder with a diameter profile measuring system, the winder being part of a slitter-winder and configured to wind customer rolls as sets of customer rolls, the winder with diameter profile measuring system comprising:
a first winding drum;
a second winding drum positioned alongside the first winding drum and positioned to support thereon overlying customer rolls to be wound;
a rider roll beam positioned above the first winding drum and the second winding drum;
a linear guide located on a longitudinal side of the rider roll beam;
a rider roll supported by the rider roll beam and configured to engage and support from above underlying customer rolls supported on the two winding drums during winding thereof, wherein the rider roll and the rider roll beam are movable in a vertical direction;
a diameter profile measuring system comprising a diameter profile measuring device mounted to a carriage which is movably supported on the linear guide; and
wherein the diameter profile measuring device comprises a measuring laser sensor, which is pivotable about a horizontal axis, such that the measuring laser sensor is adjustable between an operating position to measure the distance to an underlying customer roll, and a calibrating position which is directed toward one of the first winding roll and the second winding roll for measurement of the distance thereto for calibration measurement of the measuring laser sensor.

10. A diameter profile measuring method for measurement of diameter profile of a set of customer rolls wound in a winder of a slitter-winder, in which winder a set of customer rolls is wound on support of winding drums of the winder, and in which winder the set of customer rolls is supported from above by a rider roll supported by an overhead rider roll beam, the method comprising measuring a diameter profile of a set of customer rolls by:
moving a diameter profile measuring device on a carriage along a linear guide mounted on one longitudinal side of the overhead rider roll beam and using a measuring laser sensor of the diameter profile measuring device during the moving to measure distance to the set of customer rolls to generate a diameter profile; and
turning the profile measuring device on the carriage on a turnable attachment arrangement to direct the measuring laser sensor for calibration measurement of the measuring laser sensor.

11. The diameter profile measuring method of claim 10 wherein the diameter profile measuring is performed when the winder is slowing down or stopped.

12. The diameter profile measuring method of claim 10 wherein the diameter profile measuring is performed when the winder is for set change slowing down or stopped.

13. The diameter profile measuring method of claim 10 wherein the measuring laser sensor is turned for the calibration distance measurement of measuring distance to at least one of the winding drums by the measuring laser sensor.

14. The diameter profile measuring method of claim 10 wherein the measuring device is charged in a charging position by a charging device.

15. The diameter profile measuring method of claim 10 wherein the generated diameter profile of the customer roll set comprises a measurement result and further comprising transmitting the measurement result to a slitter-winder control system for transmitting the measurement result as back feed information to a production line control unit of a fiber web production line providing fiber web for the winder.
